(19) United States
(12) Patent Application Publication
(10) Pub. No.: US 2025/0234376 A1
(43) Pub. Date: Jul. 17, 2025

(54) ENHANCED HCCA FOR UHR CONTROLLED SCENARIOS

(71) Applicants: SONY GROUP CORPORATION, Tokyo (JP); SONY CORPORATION OF AMERICA, New York, NY (US)

(72) Inventors: Salvatore Talarico, Los Gatos, CA (US); Qing Xia, San Jose, CA (US)

(73) Assignees: SONY GROUP CORPORATION, Tokyo (JP); SONY CORPORATION OF AMERICA, New York, NY (US)

(21) Appl. No.: 18/925,226

(22) Filed: Oct. 24, 2024

Related U.S. Application Data
(60) Provisional application No. 63/620,626, filed on Jan. 12, 2024.

(51) Int. Cl. H04W 74/0808; H04W 84/12

(52) U.S. Cl. CPC H04W 74/0808; H04W 84/12

(57) ABSTRACT

A channel access procedure (protocol) for WLAN communications in controlled Ultra-High Reliability (UHR) scenarios. An initiating station (AP or non-AP) determines a stations to be idle and acquires a Transmit Opportunity (TxOP) within a specific fixed period, and may transmit for a defined portion of that period, and be idle for the remaining period. Options are described in which initiator can pause and restart, or fully terminate or truncate, transmission within that TxOP. A Global hybrid coordinator (GHC) paradigm is established for coordinating a group of APs belonging to different Basic Service Sets (BSSs).

### CROSS-REFERENCE TO RELATED APPLICATIONS

This application claims priority to, and the benefit of, U.S. provisional patent application Ser. No. 63/620,626 filed on Jan. 12, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless communications, and more particularly to improving operations in a controlled Ultra-High Reliability (UHR) network under IEEE 802.11bn.

### 2. Background Discussion

In adopting Ultra-High Reliability (UHR) capabilities for a Wireless Local Area Network (WLAN) using a Hybrid Controller (HC), issues can arise in regard to throughput, latency and Medium Access Control (MAC) Protocol Data Unit (MPDU) losses when operations involve an Overlapping Basic Service Set (OBSS).

Accordingly, a need exists for protocol enhancements that address the issues arising during OBSS communications. The present disclosure fulfills that need and provides additional benefits over existing systems.

### BRIEF SUMMARY

A channel access procedure (protocol) is described for communicating over a Wireless Local Area Network (WLAN) in controlled Ultra-High Reliability (UHR) scenarios. An initiating station (AP or non-AP) determines that the channel is idle and acquires a Transmit Opportunity (TxOP) within a specific fixed period, and is allowed to transmit for a defined portion of that period, and then it goes idle for the remaining period. In at least one embodiment, mode, or option, the initiator can pause transmission within that TxOP, and resume transmission within that TxOP.

In at least one embodiment, mode, or option, under certain conditions the initiating device can terminate, truncate, or pause their TxOP, to allow another device to transmit during the TxOP.

The disclosure describes establishing a Global Hybrid Coordinator (GHC) paradigm, which is either a logical or physical entity which coordinates a group of APs belonging to different Basic Service Sets (BSSs) in which APs belonging to the same GHC have the same fixed period and starting position of the fixed period is the same across them, as based following a global timestamp.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a communications diagram of HCF-Controlled Channel Access (HCCA) framework in IEEE 802.11e.

FIG. 2 is a block diagram of communication station hardware, according to at least one embodiment of the present disclosure.

FIG. 3 is a block diagram of Multi-Link Device (MLD) hardware according to at least one embodiment of the present disclosure.

FIG. 4 is a communications diagram of a case in which contending for the channel is performed in a more periodic and deterministic manner according to at least one embodiment of the present disclosure.

FIG. 5 is a communications diagram of an example showing the initiating device acquiring a TxOP according to at least one embodiment of the present disclosure.

FIG. 6 is a communications diagram of an example showing two APs belonging to the same Global hybrid coordinator (GHC) that have aligned fixed periods and boundaries according to at least one embodiment of the present disclosure.

FIG. 7 is a communications diagram of an example showing the relationship between the fixed period of an AP, and a fixed period of an associated non-AP STA according to at least one embodiment of the present disclosure.

FIG. 8 is a communications diagram of the case when the fixed period of a non-AP STA overlaps with an idle period of its associated AP according to at least one embodiment of the present disclosure.

FIG. 9 is a communications diagram of a case in which a non-AP STA operates as a responding device within a fixed period of the AP according to at least one embodiment of the present disclosure.

FIG. 10 is a communications diagram exemplifying another option for further reducing potential contention between a non-AP STA and AP when operating as an initiating device, according to at least one embodiment of the present disclosure.

### DETAILED DESCRIPTION

### 1. Introduction

The present disclosure defines Medium Access Control (MAC) and several Physical (PHY) layer specifications for wireless connectivity for fixed, portable, and moving Stations (STAs) within a local area, such as within IEEE P802.11bn. In particular, the aim is to add Ultra-High Reliability (UHR) capabilities to a Wireless Local Area Network (WLAN), where the capability is defined for both an isolated Basic Service Set (BSS) and overlapping BSSs, and to introduce the following elements.
(A) Providing at least one mode of operation capable of increasing throughput by 25%, as measured at the MAC data service Access Point, in at least one Signal to Interference and Noise Ratio (SINR) level (Rate-vs-Range), compared to the Extremely High Throughput (EHT) MAC/PHY operation.
(B) Providing at least one mode of operation capable of reducing latency by 25% for the 95th percentile of the latency distribution compared to EHT MAC/PHY operation;
(C) Providing at least one mode of operation capable of reducing MAC Protocol Data Unit (MPDU) loss by 25% compared to the Extremely High Throughput MAC/PHY operation for a given scenario, especially for transitions between different BSS.

It will be appreciated that the current IEEE 802.11be standard is capable of achieving multi-Gbps throughout, sub-10 ms latency and packet losses lower than 0.1%, with enhancements being necessary toward fulfilling requirements for the use cases identified for the IEEE P802.11bn project. In this matter, one of the main limitations of current IEEE 802.11be is in terms of reliability and due to the indeterministic channel access procedure which requires a mandatory Listen-Before-Talk (LBT) procedure that impacts when a transmission can be actually performed since utilization of the wireless spectrum is conditional to it being accessed only when the channel is idle.

When discussing the IEEE P802.11bn project, numerous use cases have been identified including, but not limited to: Virtual Reality (VR), industrial Internet-of-Things (IoT), logistics and smart agriculture, metaverse and enterprises business examples. Many common deployment may be characterized by three aspects: (1) extended coverage areas that require multiple APs; (2) secluded deployments or indoor deployments with generally large penetration loss with the outdoors; (3) dedicated networks with no other Radio Access Technologies (RATs), either intra or inter, in proximity. Under these considerations, it is possible to conclude that many of the use cases for the IEEE P802.11bn project would be deployed in controlled environments, while intra and inter-BSS congestion and contention would still exist while using the legacy design due to the mandatory use of the LBT mechanism which leads inevitably in loss of spectral efficiency and latencies.

### 2. HCF Controlled Channel Access in 802.11e

In IEEE 802.11e the Hybrid Coordination Function (HCF), of an HCF-Controlled Channel Access (HCCA) procedure has been introduced to establish a framework that would guarantee a specific amount of service time for connected devices.

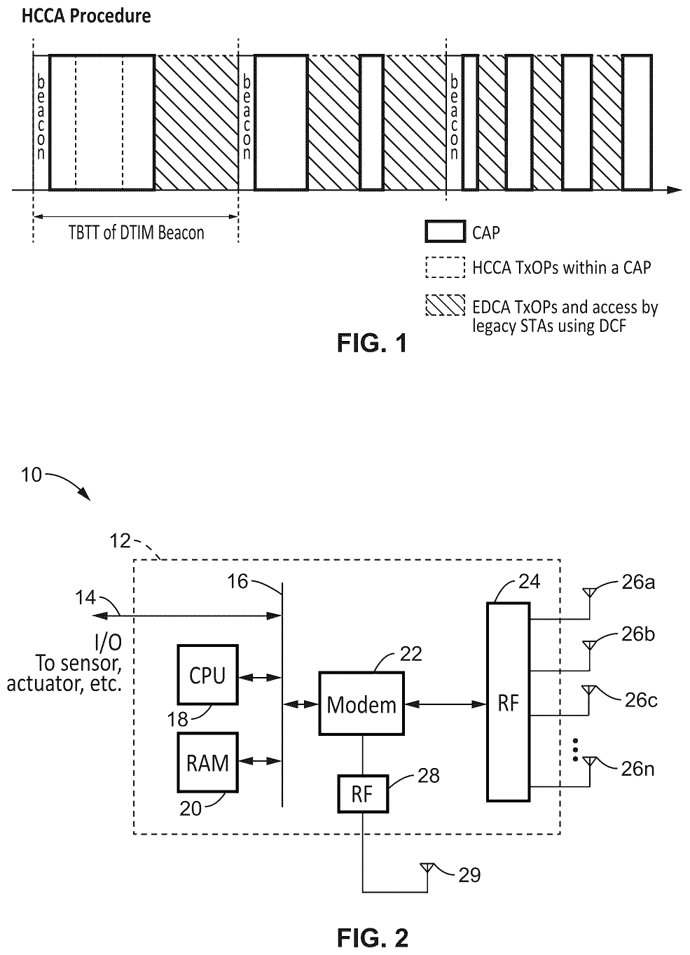

FIG. 1 illustrates operation under this HCF-Controlled Channel Access (HCCA) framework. In the figure is seen sections of the communication shown as Controlled Access Phase (CAP), HCCA Transmit Opportunities (TxOPs) within a CAP time, and Enhanced Distributed Channel Access (EDCA) TxOP and accessed by legacy stations (STAs) using Distributed Coordination Function (DCF). Under the HCCA, either an Access Point (AP) or a non-AP STA relies on a Hybrid Controller (HC), which is collocated with an AP, to obtain a TxOP and use its higher access priority to initiate frame exchange sequences and to allocate TxOPs to itself and to other non-AP STAs in order to provide limited-duration CAPs for contention free transfer of Quality-of-Service (QOS) data.

In particular, to access the wireless channel, an HC senses during a Short Interframe Space (SIF) and determines the channel idle at the transmission PCF Interframe Space (PIFS) (PCF stands for Point Coordination Function) slot boundary. Once the channel is determined to be idle, the HC either performs the first frame transmission or performs a transmission of a QoS (+) Contention-Free-Poll (CF-Poll) to set a polled TxOP. A STA may initiate multiple frame exchange sequences during a polled TxOP of sufficient duration to perform more than one such sequence. An HC initiates a TxOP within a Target Beacon Transmission Time (TBTT), and after a CAP with limited duration, it may reclaim the channel within that TBTT if the wireless medium is idle at the Transmission PIFS slot boundary. However, a TxOP may be subject to early termination if a CAP extends across a TBTT.

### 3. Problem Statement

While the legacy HCCA procedure would outperform other MAC protocols, including EDCA, in terms of decreasing congestion in controlled environments through its use of more deterministic scheduling of the polling system on which it is based, and has inherently higher priority compared to EDCA in terms of channel access acquisition (since to access the medium no backoff is required) it has some fundamental limitations, as outlined below.
(a) The Hybrid Controller (HC) is the only initiating device for an HCCA TxOP within the HCCA framework, and this represents a bottleneck in terms of latency for a non-AP STA. (b) No inter-BSS coordination is possible, so inter-BSS congestion and mutual blocking can become an issue in situations when BSSs overlap. (c) EDCA may be concurrently operated by non-AP STAs when they attempt to access a channel outside a polled TxOP, and in this case, non-AP STAs will be contending for the channel with a backoff (BO) within the same BSS.

### 4. Embodiments of the Present Disclosure

### 4.1. Communication Station (STA and MLD) Hardware

FIG. 2 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

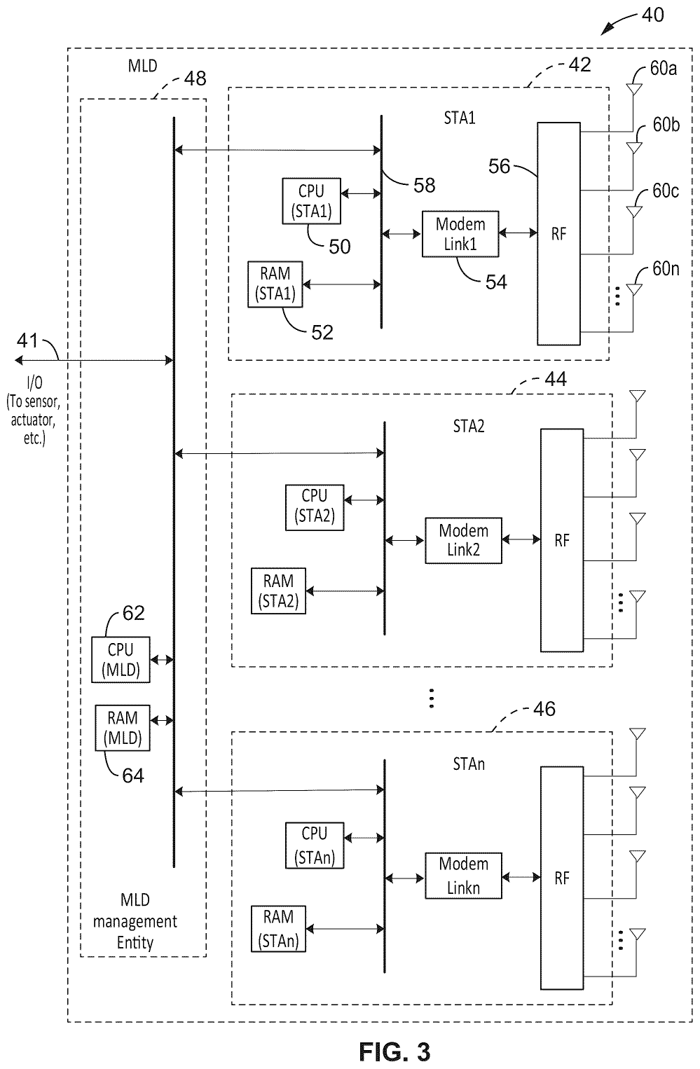

FIG. 3 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHZ), basic link set (2.4 GHz and 6 GHZ).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 4.2. Load and Frame Based Operating Modes

By means of regulatory requirements (i.e., ETSI BRAN) two modes of operation may be possible when operating in the sub-6 GHz Band: (a) Load Based Equipment (LBE), and (b) Frame Based Equipment (FBE).

The IEEE procedures, including both EDCA and HCCA, up to this point in time have been based upon the LBE framework; where devices access the channel in an opportunistic manner. However, the regulatory requirements allow a secondary framework, namely the FBE framework.

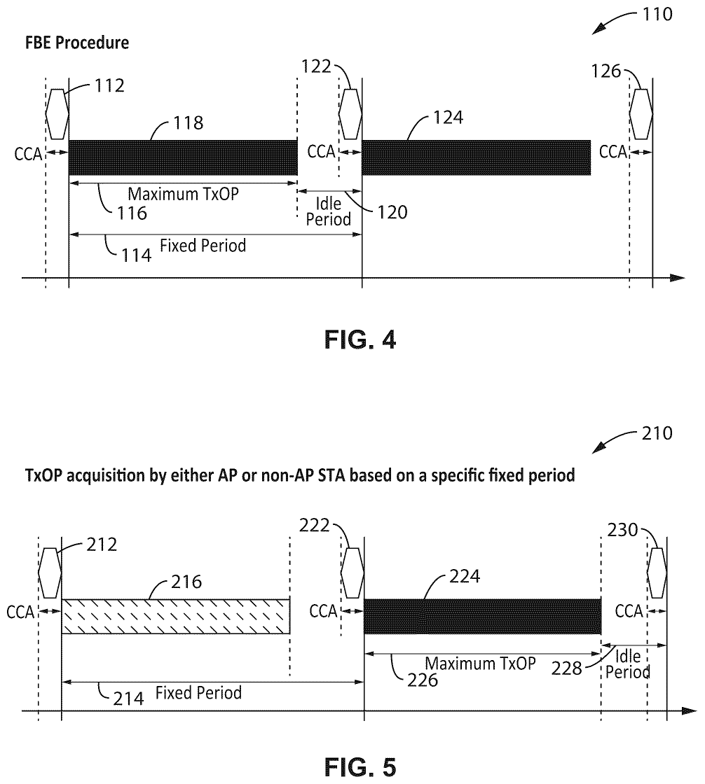

FIG. 4 illustrates an example 110 in which contending for the channel is performed in a more periodic and deterministic manner. In the figure can be seen a Clear Channel Assessment (CCA) 112, and as the channel was deemed to be idle, a TxOP was obtained. The figure depicts a maximum length 116 of this TxOP, in relation to a fixed period 114. The figure shows a transmission 118 during the TxOP and an idle period 120 afterward which extends to the end of the fixed period 114. At the end of the idle period a CCA 122 is performed and the channel obtained for transmission 124, and this continues, such as with a later CCA 126.

In this matter, the following provides short excerpt quotes of certain relevant phrases from the regulations as defined in ETSI BRAN (Broadband Radio Access Networks).
(A) “Frame Based Equipment shall implement a Listen Before Talk (LBT) based Channel Access Mechanism to detect the presence of other RLAN transmissions on an Operating Channel.”
(B) “Frame Based Equipment is equipment where the transmit/receive structure has a periodic timing with a periodicity equal to the Fixed Frame Period. A single Observation Slot as defined in clause 3.1 of “ETSI BRAN 301.893, “5 GHZ RLAN; Harmonised Standard covering the essential requirements of article 3.2 of Directive 2014/53/EU”” and as referenced by the procedure in clause 4.2.7.3.1.4 in that same directive shall have a duration of not less than 9 μs.”
(C) “The Fixed Frame Periods supported by the equipment shall be declared by the manufacturer. See clause 5.4.1, item (q). This shall be within the range of 1 ms to 10 ms. Transmissions can start only at the beginning of a Fixed Frame Period. . . . An equipment may change its Fixed Frame Period but it shall not do more than once every 200 ms.”

Item (A) indicates that for FBE channel access, the transmit/receive structure is periodic, and each frame is at most 10 ms long. Item (B) highlights that instead the frame period is generally fixed and can be modified no more than once every 200 ms. When a system operates in FBE mode, a device can be defined as: (i) an “initiating device”, which is the device that initiates a sequence of one or more transmissions; (ii) a “responding device”; (iii) or both. For an initiating device, its channel access mechanism must comply with the requirements provided in Section 4.2.7.3.1.4 in “ETSI BRAN 301.893, “5 GHZ RLAN; Harmonised Standard covering the essential requirements of article 3.2 of Directive 2014/53/EU”” (notice that this is specular for 6 GHz band), while for a responding device its set of requirements for the channel access are provided in Section 4.2.7.3.1.5 of ETSI EN 301 893 V2.1.3. In particular, for an initiating device the requirements are the following.
(a) Immediately starting transmission within a fixed frame period, it shall perform CCA. If the channel is clear, the initiating device may transmit immediately.
(b) The initiating device is allowed to perform short control signaling transmissions without sensing channel status for the presence of other signals, if (i) within an observation period of 50 ms, the number of Short Control Signaling Transmissions by the equipment shall be equal to or less than 50 ms; and (ii) the total duration of the equipment's Short Control Signaling Transmissions shall be less than 2500 μs within said observation period.
(c) Multiple transmissions are permitted within a Channel Occupancy Time (COT) if the gap between transmissions does not exceed 16 μs. Otherwise, an initiating device may perform CCA before transmission.
(d) It is allowed to grant authorization to one or more associated responding devices.
(e) The Channel Occupancy Time (COT) shall not be greater than 95% of the fixed frame period.
(f) Upon correct reception of a packet which was intended for this equipment, it can skip CCA and immediately proceed with the transmission of management and control frames (e.g., ACK and Block ACK frames). A consecutive sequence of such transmissions by the equipment, without it performing a new CCA, shall not exceed the Maximum Channel Occupancy Time

The requirements for a responding device are as follows.
(a) After the responding device has received a transmission grant from an associated initiating device, it may proceed with transmissions on the current operating channel, in the following manner. (i) The responding device may proceed with such transmissions without performing a CCA if these transmissions are initiated at most 16 μs after the last transmission by the initiating device that issued the grant. (ii) The responding device that does not proceed with such transmissions within 16 μs after the last transmission from the initiating device that issued the grant, shall perform a CCA on the Operating Channel during a single observation slot within a 25 μs period ending immediately before the granted transmission time. If CCA fails, the responding device withdraws the transmission grant; otherwise, it may perform transmissions on the current operating channel for the remaining channel occupancy time of the current fixed frame period. In this case, the responding device may have multiple transmissions on this operating channel provided that the gap in between such transmissions does not exceed 16 μs. When the transmissions by the responding device are completed, the responding device shall withdraw the transmission grant provided by the initiating device.

In this disclosure, enhancements to the HCF-Controlled Channel Access (HCCA) procedure are provided by incapsulating in this design the principles of the Frame Based Equipment (FBE) framework.

### 4.3. Channel Access Procedures and Behaviors of Present Disclosure

This section describes channel access procedures and the general behavior of APs and non-AP STAs according to the present disclosure.

In one embodiment of this invention, both an AP or a non-AP STA may operate as initiating devices and acquire their own TxOPs. A channel is assessed to be idle upon sensing the channel for the duration of a Short Interframe Space (SIF) interval and determining that the received power is below a given threshold, and finally declaring that the channel is idle at the transmission PCF Interframe Space (PIFS) slot boundary. It should be noted that this procedure is exemplified in a later part of this disclosure as a CCA procedure.

FIG. 5 illustrates an example embodiment 210 in which the STA operating as initiating device (AP or non-AP STA) can only acquire a TxOP if a determination is made that the channel is idle at the start of a pre-defined or configured fixed period.

The figure shows a negative (non-clear) CCA 212 as the channel is active 216, during a portion of fixed period 214. The figure further shows that once a device (either an AP or a non-AP STA) operating as the initiating device obtains a positive CCA 222 (channel is idle) and acquires a TxOP within the specific fixed period 214, it may be allowed to transmit 224 for a portion of that period up to a maximum TxOP 226, which is followed by an idle period 228, after which a CCA 230 is shown toward another access.

In at least one embodiment, mode or option; the portion of the period is the first 95% of that fixed period, and needs to be idle 128 for the remaining period. In at least one embodiment, mode or option; the idle period constitutes at least 5% of the fixed frame period and at least 100 μs.

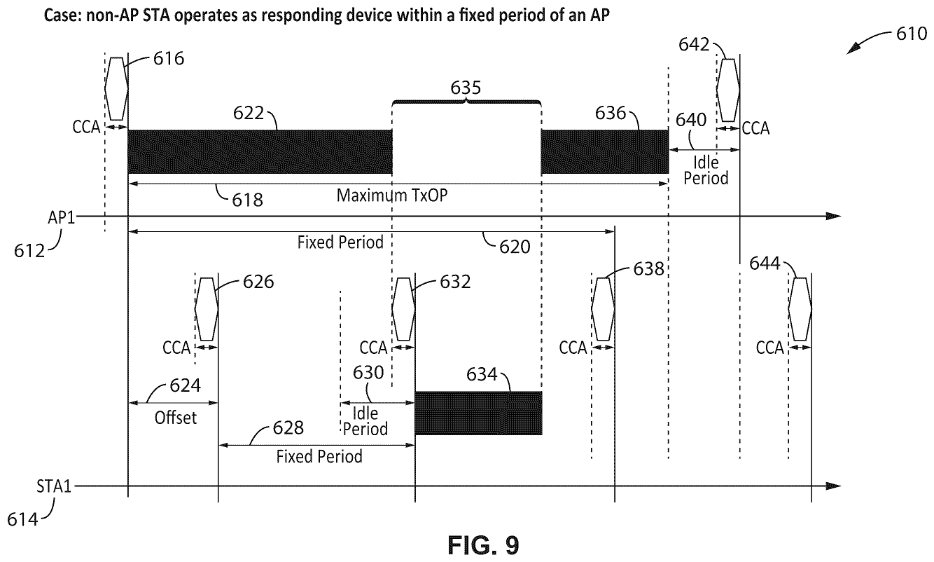

In at least one embodiment, mode or option; once a device (either an AP or a non-AP STA) operates as an initiating device and acquires a TxOP within a specific fixed period, it is allowed to pause transmission within that TxOP and then resume transmission within that TxOP. This could be represented similar to that of FIG. 9 with transmission 622, pause 635 and resumption 636, thus depicting two transmission portions within the TxOP as separated by a pause (idle). This μse of pausing is allowed according to one of the following options.

Option 1: The device reassesses whether that channel is idle upon sensing the channel for the duration of a SIFS and determining that the received power is below a given threshold, and finally declares that the channel is idle at the TxPIFS slot boundary, whereby transmission resumes within the TxOP.

Option 2: If the device transmission is assessed to start with a gap less than 16 μs from the end of any prior transmissions from other devices with which it is sharing the TxOP, the initiating device does not need to perform any sensing to reacquire ownership of the channel. However, if the initiating device transmission is assessed to start with a gap larger than 16 μs from the end of any prior transmissions from other devices with which it is sharing the TxOP, then the initiating device needs to reassess whether that channel is idle upon sensing the channel for the duration of a SIFS and determining that the received power is below a given threshold, and finally declares the channel is idle at the TxPIFS slot boundary and regains ownership of the channel.

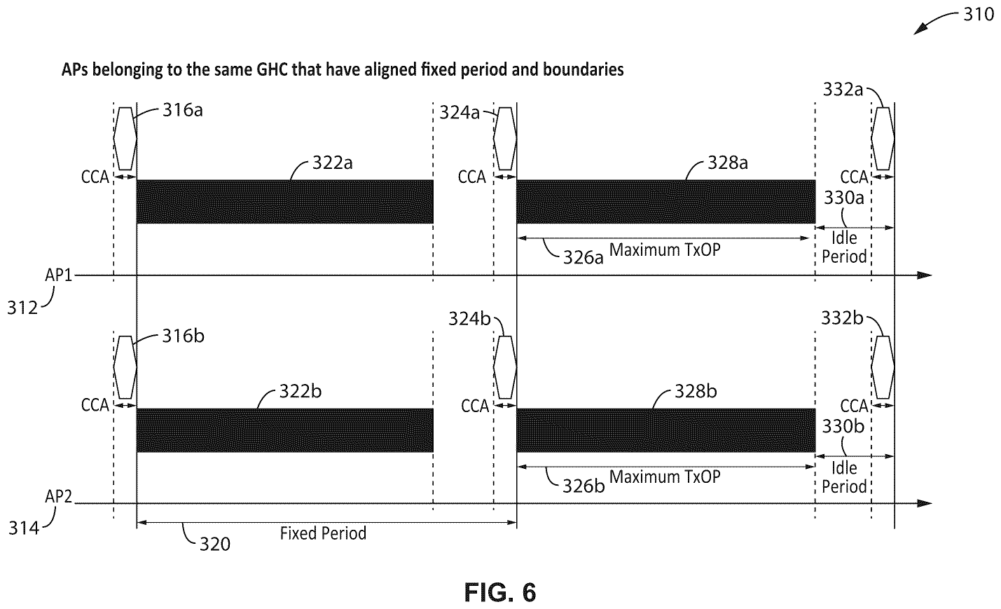

FIG. 6 illustrates an example embodiment 310 of two APs belonging to the same Global hybrid coordinator (GHC) that have aligned fixed periods and boundaries. In this embodiment, the concept of GHC is established, which is either a logical or physical entity which coordinates a group of APs belonging to different BSSs. The figure depicts communications from AP1 312 and AP2 314, each performing a CCA 316a, 316b, then within fixed period 320 each obtains a respective TxOP and performs transmission 322a, 322b, whose respective starts and ends are aligned. Before that fixed period ends, the APs perform another CCA 324a, 324b, to obtain the TxOP, outside of fixed period 320, and perform transmissions 328a, 328b, within the maximum TxOP 326a, 326b, following by an idle period 330a, 330b. The process then continues with another pair of CCAs 332a, 332b.

In at least one embodiment, mode, or option, the APs belonging to the same GHC have the same fixed period and the starting position of the fixed period is the same across them. This can be established through close time synchronization across those APs which follow a global timestamp of GHC.

In at least one embodiment, mode or option, an initiating device (whether this is an AP or a non-AP STA) entirely terminates the TxOP or truncates their TxOP or their transmissions, allowing the responding device to then obtain a portion of the TxOP, if one or more of the following conditions are met: (a) either the TxOP or the transmission within the TxOP overlaps with a Target Beacon Transmission Time (TBTT) of Delivery Traffic Indication Map (DTIM) Beacon; (b) either the TxOP or the transmission within the TxOP extends over the last portion of the fixed period which is devoted to an idle period, where the idle period is defined according to one of the embodiments described in this disclosure; (c) either the TxOP or the transmission within the TxOP extends over the idle period of another device operating within the same BSS, or within a different BSS, but belonging to a BSS which has the GHC in common.

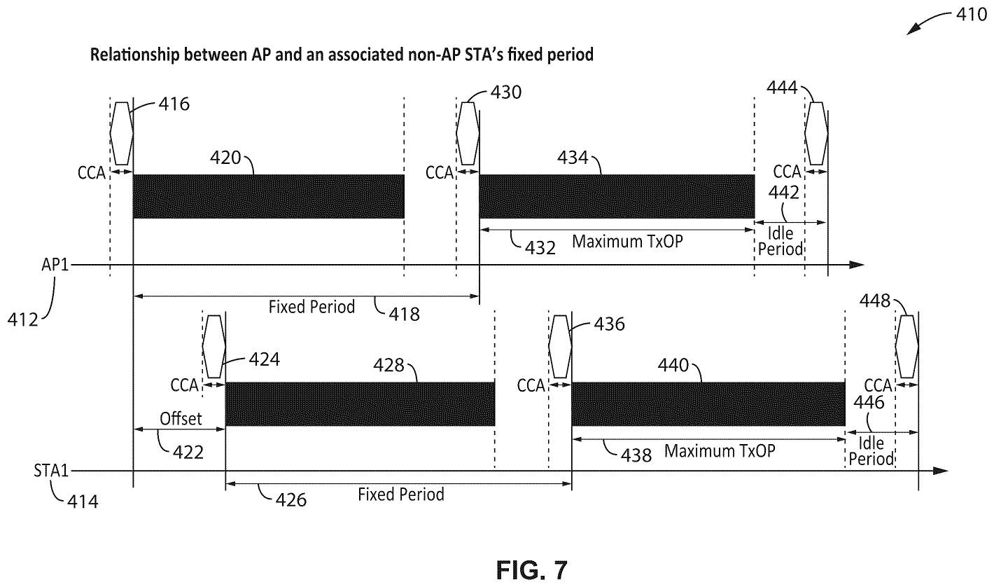

FIG. 7 illustrates an example embodiment 410 showing the relationship between the fixed period of an AP, and a fixed period of an associated non-AP STA. The figure depicts operations for AP1 412 and non-AP STA1 414. AP1 performs CCA 416, obtains the channel in fixed period 418, and performs a transmission 420. STA1 starts its CCA 424 later to obtain the channel and start its transmission 428 within a fixed period 426, which is offset 422 from the transmission start time of AP1.

This continues with AP1 performing CCA 430, obtaining the TxOP and transmitting 434 up to a maximum length 432 of the TxOP, followed by an idle period 442. STA1 also continues with CCA 436, transmission 440 within maximum TxOP 438, and followed by an idle period 446. Then AP1 and STA1 continue with new CCAs 444, 448 in new transmission attempts.

In at least one embodiment, mode, or option, the fixed period of the AP and its associated non-AP STA may be different or the same. In at least one embodiment, mode, or option, the starting position of a fixed period between an AP and a non-AP STA are different and defined by a pre-defined or pre-configured offset.

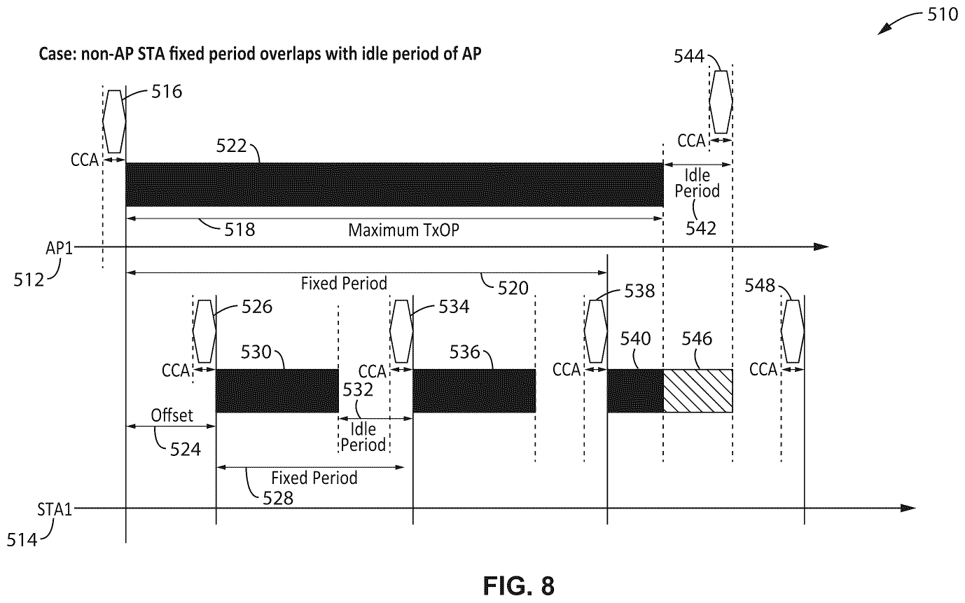

FIG. 8 illustrates an example embodiment 510 of the case when the fixed period of a non-AP STA overlaps with an idle period of its associated AP. The figure depicts operations for AP1 512 and non-AP STA1 514.

AP1 performs CCA 516, obtains the channel in fixed period 520, with a maximum TxOP 518 which extends beyond the fixed period 520. AP performs a transmission 522 followed by an idle period 542. STA1 starts its CCA 526 later, obtains the channel and starts its transmission 530 within a fixed period 528, which is offset 524 from the transmission start time of AP1. An idle period 532 follows the transmission, and is shown within the fixed period 528 for STA1. Then, while AP1 is still in the midst of its transmission 522, STA1 performs a CCA 534 and transmits 536, an just prior to the ends of the fixed period STA1 performs CCA 538 and transmission 540 outside of fixed period 520. The transmission must be terminated at the maximum TxOP 518 boundary, thereby the channel goes idle 546. Afterward, both AP1 and STA1 seek to perform new transmissions with CCA 544 and 548.

In at least one embodiment, mode, or option, the fixed period and/or TxOP of either a non-AP STA or an AP never extend so as to overlap with the the idle periods of other channels. More information about these idle periods are described elsewhere in this disclosure.

In at least one embodiment, mode, or option, while the fixed period and/or TxOP of a non-AP STA is not allowed to overlap with the idle period of an AP, in order to prioritize an AP as an initiating device over a non-AP STA, the fixed period and/or TxOP of the AP STA is allowed to overlap with the idle period of the associated non-AP STA. It will be noted that the fixed period and/or TxOP of an AP is not allowed to overlap with the idle period of a non-AP STA, in order to prioritize a non-AP STA as an initiating device over an AP, while the fixed period and/or TxOP of the non-AP STA is allowed to overlap with the idle period of the associated AP.

FIG. 9 illustrates an example embodiment 610 of a case in which a non-AP STA operates as a responding device within a fixed period of the AP. This example is configured to further improve spectral efficiency, so that the fixed period and/or TxOP utilized by the non-AP STA for transmission 634 can be performed within the idle period 635 of an AP, although it may never be allowed to overlap with the tail-end (last portion) of the idle period 640 of the AP when the AP is expected to perform the CCA procedure to acquire the subsequent fixed period (e.g., last 25 μs of the idle period).

The figure depicts operations for AP1 612 and non-AP STA1 614. AP1 performs CCA 616, obtains the channel in fixed period 620, with a maximum TxOP 618 which extends beyond the fixed period 620, and performs a transmission 622, then waits in idle period 635 for STA1 to respond.

STA1 initially started with a CCA 626 at offset 624, but does not transmit during fixed period 628, and at the end of transmission 622 from AP1 and within idle period 630, STA1 performs CCA 632 to obtain the channel to send responsive transmission 634. Upon receiving transmission 634, AP1 then resumes by sending transmission 636 within the maximum TxOP 618.

STA1 attempts to obtain the channel with CCA 638 used at the end of the fixed period 620, but channel is not idle. The figure depicts subsequent attempts of AP1 with a CCA 642 at the end of idle period 640, and a later CCA 644 by STA1.

In at least one embodiment, mode, or option, the AP is not allowed to transmit within the idle period of a non-AP STA or within the tail-end (latter portion) of the idle period during the time period when the non-AP STA is expected to perform the CCA procedure to acquire a subsequent Fixed Frame Period (FFP) (e.g., last 25 μs of the idle period), whether this operates as an initiating or a responding device.

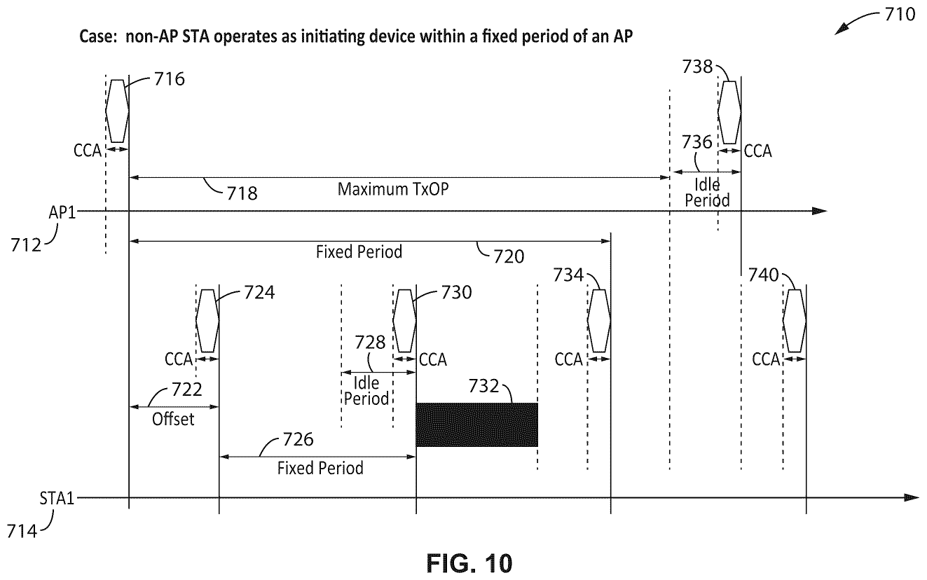

FIG. 10 illustrates an example embodiment 710 which provides a different option toward further reducing potential contention between a non-AP STA and an AP. In at least one embodiment, mode, or option a non-AP STA is allowed to conditionally operate as an initiating device if the AP fails to acquire the channel at the beginning of its fixed period. In other words, within an AP's fixed period, a non-AP STA is allowed to operate as an initiating device only if the AP has failed to acquire the channel for that fixed period.

In this case, the behavior of the non-AP STA is exemplified as follows. (a) A non-AP STA can monitor/attempt a detection of an AP transmission at the beginning of the fixed period. (b) Once the non-AP STA assesses that the AP has failed to acquire the channel and has not initiated a transmission within that fixed period, the non-AP STA can operate as an initiating device and assess that the channel is idle upon sensing for the duration of a SIFS and by determining that the received power is below a given threshold, and finally declares the channel idle at the TxPIFS slot boundary which corresponds with the start of the starting point of the non-AP STA's fixed period.

The figure shows a specific example with communications shown from AP1 712 and STA1 714. AP1 performs CCA 716, but does not perform a transmission in fixed period 720 within the maximum TxOP 718 duration. STA1 performs CCA 724, after offset 722 from that of the start of the fixed period 720, yet it does not access the channel during fixed period 726, but is trying to detect a transmission from AP1. Having not received the transmission, STA1 performs a CCA 730 at the end of idle period 728, obtains the channel and transmits 732 to AP1. Processing continues highlighted with additional CCA 734, CCA 738 in idle period 736, and CCA 740.

It should be noted that the embodiments, modes, options listed in the above section are not mutually exclusive, and one or more of them may apply together.

### 4.4. Framework and Signaling

In at least one embodiment, mode, or option, in order to enable the procedure described in the prior section explicit signaling is provided within the preamble. In particular, this may be contained within the High Efficiency (HE) Signal A or HE Signal B and the Universal Signal (U-SIG), as follows.
(a) In at least one embodiment, mode, or option, one of the reserved bits of the HE-SIG-A1 is used to indicate, or be interpreted, as whether the legacy procedure or the procedure described in the prior section is to be used. For example, a bit set to a first state (e.g., “1”) for indicating that the described procedure is utilized; while that bit set to a second state (e.g., “0”) indicates that the legacy behavior is to be used.
(b) In at least one embodiment, mode, or option, one of the reserved bits of the HE-SIG-A2 is used to indicate whether the legacy procedure or the procedure described in the prior section is used. For example, setting the bit to a first state (e.g., “1”) indicates that the disclosed procedure is to be used; while if that bit is set to a second state (e.g., “0”) then the legacy behavior is to be used.
(c) In at least one embodiment, mode, or option, one of the reserved bits of the HE-SIG-B is used to indicate whether the legacy procedure or the procedure described in the prior section is used. For example, setting this bit to a first state (e.g., “1”) indicates that the disclosed procedure is utilized; while if the bit is set to a second state (e.g., “0”) then the legacy behavior is to be followed.
(d) In at least one embodiment, mode, or option, one of the reserved bits of the U-SIG is used to indicate whether the legacy procedure or the procedure described in the prior section is used. For example, setting this bits to a first state (e.g., “1”) indicates that the disclosed procedure is to be utilized; while setting this bit to a second state (e.g., “0”) indicates that the legacy behavior is to be used.

In at least one embodiment, mode, or option, the indication of an Access Category (AC) may be ignored by either an AP or a non-AP STA from a channel access perspective, as neither an AP or a non-AP STA may perform any backoff when sensing the wireless medium for channel occupancy and may instead perform a CCA as described in this disclosure.

In at least one embodiment, mode, or option, the Transmission Vector (TXVECTOR) which defines the data rate, maximum length of MPDU, and other parameters is also complemented with one or more parameters. By way of example and not limitation, a FIXED_PERIOD value may be utilized to indicate the length of a fixed period of an AP as defined according to the present disclosure.

In at least one embodiment, mode, or option, the Receiver Vector (RXVECTOR) is complemented with one or more parameters, such as FIXED_PERIOD, which indicated the length of a fixed period of an AP as defined along this disclosure.

In at least one embodiment, mode, or option, the High Efficiency-Signal A (HE-SIG-A), or the HE-SIG-B field, or the U-SIG field may include an indication related to the length of a fixed period of an AP as defined along this disclosure by either using any of the reserved bits or repurposing existing fields. It should be noted that the HE-SIG-A field is generally used to decode the MCS index in 802.11ax, while the HE-SIG-B field is used in 802.11ax MU PPDU; while U-SIG field the contains the parameters necessary to interpret an EHT PPDU.

### 5. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD), and in which said STA can operate as an access point (AP) or as a non-AP STA; (c) wherein at least one said STA, operating as an AP within a given basic service set (BSS) is configured for connecting to a hybrid controller (HC) which controls multiple APs in overlapping BSSs (OBSSs); (d) a processor of said STA; (e) a non-transitory memory storing instructions executable by the processor for wirelessly communicating with other STAs on a IEEE 802.11 wireless local area network (WLAN); and (f) wherein said instructions, when executed by the processor, perform steps of a wireless communications protocol having the following channel access procedure for ultra-high reliability (UHR) communication scenarios, comprising: (f)(i) establishing a global hybrid coordinator (GHC) paradigm which is either a logical or physical entity which coordinates a group of APs belonging to different BSSs controlled by the same HC; and wherein APs belonging to the same GHC have the same fixed period and starting position of the fixed period is the same across them; (f)(ii) determining that a channel is idle, by an initiating station that is either an AP or non-AP STA; (f)(iii) acquiring a transmit opportunity (TxOP) on the channel within a specific fixed period; and (f)(iv) transmitting for a defined portion of that specific fixed period, and then completing or halting transmission so that the channel is idle for the remainder of the specific fixed period.

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD), and in which said STA can operate as an access point (AP) or as a non-AP STA; (c) wherein at least one said STA, operating as an AP within a given basic service set (BSS) is configured for connecting through to a hybrid controller (HC) which controls multiple APs in overlapping BSSs (OBSSs); (d) a processor of said STA; (e) a non-transitory memory storing instructions executable by the processor for wirelessly communicating with other STAs on a IEEE 802.11 wireless local area network (WLAN); and (f) wherein said instructions, when executed by the processor, perform steps of a wireless communications protocol having the following channel access procedure for ultra-high reliability (UHR) communication scenarios, comprising: (f)(i) establishing a global hybrid coordinator (GHC) paradigm which is either a logical or physical entity which coordinates a group of APs belonging to different BSSs controlled by the same HC; and wherein APs belonging to the same GHC have the same fixed period and starting position of the fixed period is the same across them; (f)(ii) determining that a channel is idle at the start of a pre-defined or configured fixed period, by an initiating station that is either an AP or non-AP STA; (f)(iii) acquiring a transmit opportunity (TxOP) on the channel within a specific fixed period; (f)(iv) transmitting for a defined portion of that specific fixed period, and then completing or halting transmission so that the channel is idle for the remainder of the specific fixed period; and (f)(v) wherein said initiator can pause, terminate or truncate transmission within said TxOP.

A method for performing channel access under controlled ultra-high reliability (UHR) scenarios when communicating in a wireless network, comprising: (a) communicating between stations (STAs) on a IEEE 802.11 wireless local area network (WLAN), where each STA is a separate STA or as a STA within a multiple-link device (MLD), and in which said STA can operate as an access point (AP) or as a non-AP STA; (b) wherein at least one said STA, operating as an AP within a given basic service set (BSS) is configured for connecting to a hybrid controller (HC) which controls multiple APs in overlapping BSSs (OBSSs); (c) establishing a global hybrid coordinator (GHC) paradigm which is either a logical or physical entity which coordinates a group of APs belonging to different BSSs controlled by the same HC; and wherein APs belonging to the same GHC have the same fixed period and starting position of the fixed period is the same across them; (d) determining that a channel is idle, by an initiating station that is either an AP or non-AP STA; (e) acquiring a transmit opportunity (TxOP) on the channel within a specific fixed period; and (f) transmitting for a defined portion of that specific fixed period, and then completing or halting transmission so that the channel is idle for the remainder of the specific fixed period.

A channel access apparatus or method for controlled UHR scenarios, in which both an AP or a non-AP STA may operate as initiating devices and acquire their TxOP; wherein a channel is assessed to be idle upon sensing the channel for the duration of a SIFS and it is determined that the received power is below a given threshold, whereby the channel is declared idle at the TxPIFS slot boundary.

The apparatus or method of any preceding implementation, wherein said initiating device can only acquire a TxOP after the initiating device first determines that the channel is idle at the start of a pre-defined or configured fixed period.

The apparatus or method of any preceding implementation, wherein the initiator pauses transmission within said TxOP, and later resumes transmission within that same TxOP.

The apparatus or method of any preceding implementation, wherein the initiating device can entirely terminate, or truncate, its TxOP.

The apparatus or method of any preceding implementation, wherein a channel is assessed to be idle upon sensing the channel for the duration of a short interframe space (SIF) and determining that the received power is below a given threshold, and finally declares the channel idle at the transmission PCF interframe Space (TxPIFS) slot boundary.

The apparatus or method of any preceding implementation, wherein said fixed period for an AP and its associated non-AP STA can be of different lengths.

The apparatus or method of any preceding implementation, wherein said fixed period for an AP and a non-AP STA can commence at different times as determined by a pre-defined or pre-configured offset.

The apparatus or method of any preceding implementation, wherein an initiating device can entirely terminate, truncate or pause, the TxOP to allow a responding device to perform a transmission within the TxOP.

The apparatus or method of any preceding implementation, wherein said initiating device allows the responding device to transmit within the TxOP if at least one of the following conditions are met: (a) either the TxOP, or the transmission within the TxOP, is overlapping with a target beacon transmission time (TBTT) of a delivery traffic indication map (DTIM) beacon; or (b) either the TxOP, or the transmission within the TxOP, is allowed to extend over the last portion of the fixed period which is devoted for idle period; or (c) either the TxOP or the transmission within the TxOP is allowed to extend over the idle period of another device operating within the same BSS or within a different BSS, but belonging to a BSS which has the GHC in common.

The apparatus or method of any preceding implementation, wherein said fixed period, and/or said TxOP, is not to extend and thus overlap with idle periods of other APs and STAs.

The apparatus or method of any preceding implementation, wherein said fixed period, and/or said TxOP, of an AP is not allowed to overlap with the idle period of a non-AP STA, to thus prioritize a non-AP STA as initiating device over an AP.

The apparatus or method of any preceding implementation, wherein said fixed period, and/or TxOP, of a non-AP STA can continue within the idle period of an AP, yet is not allowed to overlap with the tail portion of the idle period during which the AP is expected to determine whether the channel is idle prior to acquiring a subsequent fixed period.

The apparatus or method of any preceding implementation, wherein an AP, whether operating as an initiating or a responding device, is not allowed to transmit within the idle period of a non-AP STA or within the tail portion of the idle period during which the non-AP STA is expected to determine whether the channel is idle prior to acquiring the subsequent fixed frame period (FFP).

The apparatus or method of any preceding implementation, wherein subject to the AP failing to acquire the channel at the beginning of its fixed period, a non-AP STA is allowed to operate as an initiating device within a fixed period of the AP.

The apparatus or method of any preceding implementation, wherein said STA, operating as a non-AP STA detects that the AP has failed to acquire the channel and has not initiated a transmission within that fixed period, then the non-AP STA operates as an initiating device, determines that the channel is idle, and declares the channel idle at the transmission PCF interframe Space (TxPIFS) slot boundary which corresponds with starting point of the fixed period for the non-AP STA.

The apparatus or method of any preceding implementation, the AP and non-AP STA operating as initiating device can only acquire a TxOP if such procedure described in claim 2 is performed at the start of a pre-defined or configured fixed period.

The apparatus or method of any preceding implementation, wherein once a device (either an AP or a non-AP STA) operates as initiating device and acquire a TxOP within a specific fixed period it may be allowed to transmit for the first 95% of that period, and may need to be idle for the remaining period, which is indicated as idle period. In one option the idle period constitutes at least 5% of the fixed frame period and at least 100 us.

The apparatus or method of any preceding implementation, wherein once a device (either an AP or a non-AP STA) operates as initiating device and acquire a TxOP within a specific fixed period, it may be allowed to pause transmission within that TxOP and it resumes transmission within that TxOP according to one of the following options: (a) (Option 1) the device reassesses whether that channel is idle upon sensing the channel for the duration of a SIFS and determining that the received power is below a given threshold, and finally declares the channel is idle at the TxPIFS slot boundary; (b) (Option 2) if the device transmission is assessed to start with a gap less than 16 us from the end of any prior transmissions from other devices with which it is sharing the TxOP, the initiating device may not need to perform any sensing to reacquire ownership of the channel. However, if the initiating device transmission is assessed to start with a gap larger than 16 μs from the end of any prior transmissions from other devices with which it is sharing the TxOP, the initiating device may need to reassesses whether that channel is idle upon sensing the channel for the duration of a SIFS and determining that the received power is below a given threshold, and finally declares the channel is idle at the TxPIFS slot boundary and regains ownership of the channel.

The apparatus or method of any preceding implementation, wherein the concept of Global hybrid coordinator (GHC) is established, which is either a logical or physical entity which coordinates a group of APs belonging to different BSSs.

The apparatus or method of any preceding implementation, wherein the APs belonging to the same GHC have the same fixed period and the starting position of the fixed period is the same across them.

The apparatus or method of any preceding implementation, wherein an initiating device (whether this is an AP or a non-AP STA) may terminate entirely the TxOP or truncate their TxOP or their transmissions within the TxOP of another device where they serve as responding devices if one or more of the following conditions are met: (a) either the TxOP or the transmission within the TxOP may overlap with a TBTT of DTIM Beacon; (b) either the TxOP or the transmission within the TxOP may extend over the last portion of the fixed period which is devoted for idle period, where the idle period is defined according to one of the embodiments provided along this disclosure; (c) either the TxOP or the transmission within the TxOP may extend over the idle period of another device operating within the same BSS or within a different BSS but belonging to a BSS which has the HGC in common.

The apparatus or method of any preceding implementation, wherein the fixed period of an AP and the associated non-AP STA may be different or the same.

The apparatus or method of any preceding implementation, wherein the starting position of a fixed period between an AP and a non-AP STA may be different and defined by a pre-defined or pre-configured offset.

The apparatus or method of any preceding implementation, wherein the fixed period and/or TxOP of either a non-AP STA or an AP may never extend and overlap with each other idle periods, where the idle period is defined based upon one the embodiments provides along this disclosure.

The apparatus or method of any preceding implementation, wherein while the fixed period and/or TxOP of a non-AP STA may not be allowed to overlap with the idle period of an AP, in order to prioritize an AP as initiating device over a non-AP STA, the vice versa may be allowed.

The apparatus or method of any preceding implementation, wherein the non-AP STA's fixed period and/or TxOP of a non-AP STA may always continue within the idle period of an AP, but may be never allowed to overlap with the tail of the idle period where the AP is expected to perform the CCA procedure to acquire the subsequent fixed period (e.g. last 25 us of the idle period).

The apparatus or method of any preceding implementation, wherein an AP is not allowed to transmit within the idle period of a non-AP STA or within the tail of the idle period where the non-AP STA is expected to perform the CCA procedure to acquire the subsequent FFP (e.g. last 25 us of the idle period), whether this operates as an initiating or a responding device.

The apparatus or method of any preceding implementation, wherein a non-AP STA may be allowed to operate as an initiating device conditionally to the AP failing to acquire the channel at the beginning of its fixed period. In other words, within an AP's fixed period, a non-AP STA is allowed to operate as an initiating device only if the AP has failed to acquire the channel for that fixed period. In this case, the UE behavior may be as follows: (a) the apparatus or method of any preceding implementation, wherein a non-AP STA may monitor/attempt a detection of an AP transmission at the beginning of the fixed period; (b) once the non-AP STA assesses that the AP has failed to acquire the channel and has not initiated a transmission within that fixed period, the non-AP STA can operate as an initiating device and assess that the channel is idle upon sensing for the duration of a SIFS and by determining that the received power is below a given threshold, and finally declares the channel idle at the TxPIFS slot boundary which corresponds with the start of the starting point of the non-AP STA's fixed period.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to +0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD), and in which said STA can operate as an access point (AP) or as a non-AP STA;
(c) wherein at least one said STA, operating as an AP within a given basic service set (BSS) is configured for connecting to a hybrid controller (HC) which controls multiple APs in overlapping BSSs (OBSSs);
(d) a processor of said STA;
(e) a non-transitory memory storing instructions executable by the processor for wirelessly communicating with other STAs on a IEEE 802.11 wireless local area network (WLAN); and
(f) wherein said instructions, when executed by the processor, perform steps of a wireless communications protocol having the following channel access procedure for ultra-high reliability (UHR) communication scenarios, comprising:
(i) establishing a global hybrid coordinator (GHC) paradigm which is either a logical or physical entity which coordinates a group of APs belonging to different BSSs controlled by the same HC; and wherein APs belonging to the same GHC have the same fixed period and starting position of the fixed period is the same across them;
(ii) determining that a channel is idle, by an initiating station that is either an AP or non-AP STA;
(iii) acquiring a transmit opportunity (TxOP) on the channel within a specific fixed period; and
(iv) transmitting for a defined portion of that specific fixed period, and then completing or halting transmission so that the channel is idle for the remainder of the specific fixed period.

2. The apparatus in claim 1, wherein said initiating device can only acquire a TxOP after the initiating device first determines that the channel is idle at the start of a pre-defined or configured fixed period.

3. The apparatus in claim 1, wherein the initiator pauses transmission within said TxOP, and later resumes transmission within that same TxOP.

4. The apparatus in claim 1, wherein the initiating device can entirely terminate, or truncate, its TxOP.

5. The apparatus in claim 1, wherein a channel is assessed to be idle upon sensing the channel for the duration of a short interframe space (SIF) and determining that the received power is below a given threshold, and finally declares the channel idle at the transmission PCF interframe Space (TxPIFS) slot boundary.

6. The apparatus in claim 1, wherein said fixed period for an AP and its associated non-AP STA can be of different lengths.

7. The apparatus in claim 6, wherein said fixed period for an AP and a non-AP STA can commence at different times as determined by a pre-defined or pre-configured offset.

8. The apparatus in claim 1, wherein an initiating device can entirely terminate, truncate or pause, the TxOP to allow a responding device to perform a transmission within the TxOP.

9. The apparatus in claim 1, wherein said initiating device allows the responding device to transmit within the TxOP if at least one of the following conditions are met:
(a) either the TxOP, or the transmission within the TxOP, is overlapping with a target beacon transmission time (TBTT) of a delivery traffic indication map (DTIM) beacon; or
(b) either the TxOP, or the transmission within the TxOP, is allowed to extend over the last portion of the fixed period which is devoted for idle period; or
(c) either the TxOP or the transmission within the TxOP is allowed to extend over the idle period of another device operating within the same BSS or within a different BSS, but belonging to a BSS which has the GHC in common.

10. The apparatus in claim 1, wherein said fixed period, and/or said TxOP, is not to extend and thus overlap with idle periods of other APs and STAs.

11. The apparatus in claim 1, wherein said fixed period, and/or said TxOP, of an AP is not allowed to overlap with the idle period of a non-AP STA, to thus prioritize a non-AP STA as initiating device over an AP.

12. The apparatus in claim 1, wherein said fixed period, and/or TxOP, of a non-AP STA can continue within the idle period of an AP, yet is not allowed to overlap with the tail portion of the idle period during which the AP is expected to determine whether the channel is idle prior to acquiring a subsequent fixed period.

13. The apparatus in claim 1, wherein an AP, whether operating as an initiating or a responding device, is not allowed to transmit within the idle period of a non-AP STA or within the tail portion of the idle period during which the non-AP STA is expected to determine whether the channel is idle prior to acquiring the subsequent fixed frame period (FFP).

14. The apparatus in claim 1, wherein subject to the AP failing to acquire the channel at the beginning of its fixed period, a non-AP STA is allowed to operate as an initiating device within a fixed period of the AP.

15. The apparatus in claim 1, wherein said STA, operating as a non-AP STA detects that the AP has failed to acquire the channel and has not initiated a transmission within that fixed period, then the non-AP STA operates as an initiating device, determines that the channel is idle, and declares the channel idle at the transmission PCF interframe Space (TxPIFS) slot boundary which corresponds with starting point of the fixed period for the non-AP STA.

16. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD), and in which said STA can operate as an access point (AP) or as a non-AP STA;
(c) wherein at least one said STA, operating as an AP within a given basic service set (BSS) is configured for connecting through to a hybrid controller (HC) which controls multiple APs in overlapping BSSs (OBSSs);
(d) a processor of said STA;
(e) a non-transitory memory storing instructions executable by the processor for wirelessly communicating with other STAs on a IEEE 802.11 wireless local area network (WLAN); and
(f) wherein said instructions, when executed by the processor, perform steps of a wireless communications protocol having the following channel access procedure for ultra-high reliability (UHR) communication scenarios, comprising:
(i) establishing a global hybrid coordinator (GHC) paradigm which is either a logical or physical entity which coordinates a group of APs belonging to different BSSs controlled by the same HC; and wherein APs belonging to the same GHC have the same fixed period and starting position of the fixed period is the same across them;
(ii) determining that a channel is idle at the start of a pre-defined or configured fixed period, by an initiating station that is either an AP or non-AP STA;
(iii) acquiring a transmit opportunity (TxOP) on the channel within a specific fixed period;
(iv) transmitting for a defined portion of that specific fixed period, and then completing or halting transmission so that the channel is idle for the remainder of the specific fixed period; and
(v) wherein said initiator can pause, terminate or truncate transmission within said TxOP.

17. The apparatus in claim 16, wherein a channel is assessed to be idle upon sensing the channel for the duration of a short interframe space (SIF) and determining that the received power is below a given threshold, and finally declares the channel idle at the transmission PCF interframe Space (TxPIFS) slot boundary.

18. The apparatus in claim 16, wherein said fixed period for an AP and its associated non-AP STA can be of different lengths; and wherein said fixed period for an AP and a non-AP STA can commence at different times as determined by a pre-defined or pre-configured offset.

19. The apparatus in claim 16, wherein said initiating device allows the responding device to transmit within the TxOP if at least one of the following conditions are met:
(a) either the TxOP, or the transmission within the TxOP, is overlapping with a target beacon transmission time (TBTT) of a delivery traffic indication map (DTIM) beacon; or
(b) either the TxOP, or the transmission within the TxOP, is allowed to extend over the last portion of the fixed period which is devoted for idle period; or
(c) either the TxOP or the transmission within the TxOP is allowed to extend over the idle period of another device operating within the same BSS or within a different BSS, but belonging to a BSS which has the GHC in common.

20. A method for performing channel access under controlled ultra-high reliability (UHR) scenarios when communicating in a wireless network, comprising:
(a) communicating between stations (STAs) on a IEEE 802.11 wireless local area network (WLAN), where each STA is a separate STA or as a STA within a multiple-link device (MLD), and in which said STA can operate as an access point (AP) or as a non-AP STA;
(b) wherein at least one said STA, operating as an AP within a given basic service set (BSS) is configured for connecting to a hybrid controller (HC) which controls multiple APs in overlapping BSSs (OBSSs);
(c) establishing a global hybrid coordinator (GHC) paradigm which is either a logical or physical entity which coordinates a group of APs belonging to different BSSs controlled by the same HC; and wherein APs belonging to the same GHC have the same fixed period and starting position of the fixed period is the same across them;
(d) determining that a channel is idle, by an initiating station that is either an AP or non-AP STA;
(e) acquiring a transmit opportunity (TxOP) on the channel within a specific fixed period; and
(f) transmitting for a defined portion of that specific fixed period, and then completing or halting transmission so that the channel is idle for the remainder of the specific fixed period.
